(19) United States
(12) Patent Application Publication
(10) Pub. No.: US 2015/0356697 A1
(43) Pub. Date: Dec. 10, 2015

(54) SYSTEM AND METHOD FOR CENTRALIZED LITIGATION DATA MANAGEMENT

(71) Applicant: Hartford Fire Insurance Company, Hartford, CT (US)

(72) Inventors: Sandra J. Falcetta, East Hampton, CT (US); Kelly A. Fortier, East Granby, CT (US); Daniela L. James, Newington, CT (US); Michael W. Johnson, Hartford, CT (US); Tina M. Levine, Windsor Locks, CT (US); Joan A. Ryken, Salem, CT (US); Mary Bramble Scott, West Hartford, CT (US); Kathy A. Vecchiarelli, Aiken, SC (US)

(21) Appl. No.: 14/299,587

(22) Filed: Jun. 9, 2014

(51) Int. Cl. G06Q 50/18; G06Q 10/10

(52) U.S. Cl. CPC G06Q 50/18; G06Q 10/10

(57) ABSTRACT

A computer system tracks litigation cases at an insurance company. The computer system provides centralized storage for litigation case data, and causes display devices to display data related to the litigation cases. The data may relate to amounts recovered by the insurance company in subrogation actions, amounts recovered by the insurance company in connection with frivolous claims that it is forced to defend, and/or costs incurred by the insurance company in bringing an interpleader action. The computer system may limit access to retrieved litigation data to authorized individuals and/or to authorized subject areas.

### FIELD

The present invention relates to computer systems and more particularly to computer systems that may aid in managing litigation at an insurance company.

### BACKGROUND

For major insurance companies, management of litigation is an important aspect of their enterprise. For some types of policies, it is an intrinsic part of the insurance contract that the insurer will defend legal actions brought against policy holders. For a large insurer with a number of lines of business, disputes may arise in which the insurer is itself directly named as a defendant. Legal process papers may be served on a large insurer in considerable volume; if subpoenas are included, the number of served papers requiring responses may run well up into the thousands on an annual basis. Among the thousands of served papers, there may be hundreds that indicate the start of a legal action that the insurer must defend.

With respect to both subpoenas and legal complaints, there may be variations in the types of documents or the related cases that call for variations in how the matters are to be handled and tracked. Among other factors, different departments of the insurer may be charged with handling the various matters, and may find different procedures most effective in directing their short- and long-term response to legal process. At the same time, the present inventors have recognized that it is desirable to provide centralized resources to the various departments to aid them in their litigation management efforts, while supporting the various differences in procedures that the different departments may find to be most effective.

### SUMMARY

A computer system is disclosed for tracking litigation cases at an insurance company. The computer system includes a centralized data storage module. Functions performed by the data storage module include receiving, storing and providing access to data related to litigation cases.

The computer system also includes a computer processor that executes program instructions and is coupled to the data storage module.

Further included in the computer system is a program memory, coupled to the computer processor, and which stores program instruction steps for execution by the computer processor.

In addition, the computer system includes an input device, which is coupled to the computer processor. The input device is operative to input at least some of the data relating to the litigation cases.

Still further included in the computer system is a display device. The display device is coupled to the computer processor. The display device is for displaying data retrieved from the centralized data storage module, which data is related to the litigation cases. The data displayed may relate to amounts recovered by the insurance company in subrogation actions, amounts recovered by the insurance company in connection with frivolous claims that it defends, and costs incurred by the insurance company in bringing interpleader actions.

A computer system of this type may streamline entry and management of information related to the litigation caseload of a large insurance company. The computer system may be configured to provide different sets of data entry forms to different departments of the insurance company, thereby supporting department-specific litigation management procedures.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 is a block diagram that illustrates aspects of an enterprise computer system provided in a large insurance company in accordance with some embodiments of the invention.

FIG. 2 illustrates access to a portion of the system of FIG. 1 using a myriad of different interfaces.

FIG. 3 is a block diagram that shows hardware and software aspects of a litigation tracker that is part of the system of FIG. 1.

FIG. 3A illustrates aspects of an application program that controls operations of the litigation tracker of FIG. 3.

FIG. 4 is a high level flow chart that illustrates aspects of task-handling by the litigation tracker of FIG. 3.

FIG. 5 is a more detailed, and life-cycle-oriented, flow chart illustration of operations of the litigation tracker of FIG. 3.

FIG. 6 is an example workload dashboard screen shot provided by the litigation tracker.

FIGS. 7-11 are example data entry forms that may be displayed by the litigation tracker in connection with intake processing for a new litigation case.

FIG. 12 is an example data entry form that may be displayed by the litigation tracker in connection with selection of outside counsel to handle a new litigation case.

FIGS. 13 and 13A are example data entry forms that may be displayed by the litigation tracker in connection with calendaring events related to a litigation case.

FIG. 14 is an example data entry form that may be displayed by the litigation tracker in connection with trial, arbitration or mediation proceedings in a litigation case.

FIG. 15 is an example data entry form that may be displayed by the litigation tracker in regard to a dollar amount recovered by the insurance company with respect to a litigation case.

FIG. 16 is an example data entry form that may be displayed by the litigation tracker in connection with an interpleader action instituted by the insurance company.

FIG. 17 is a flow chart that illustrates a process that may be performed to handle a subpoena with support from the litigation tracker.

FIGS. 18-20 are example data entry forms that may be displayed by the litigation tracker in connection with handling a subpoena.

FIGS. 21-23 are simplified examples of reports of litigation data that may be generated by the litigation tracker.

### DETAILED DESCRIPTION

In general, and for the purposes of introducing concepts of embodiments of the present invention, a computer system with centralized data storage and retrieval facilitates management of litigation by an insurance company. “Litigation tracker” software running on the computer system provides standardized data entry forms for use by company employees in entering data about litigation cases. Although the forms are standardized, different sets of standard forms may be provided by the central litigation tracker to different departments of the insurance company, to support procedures that each department tailors for itself to most conveniently manage the types of litigation it encounters.

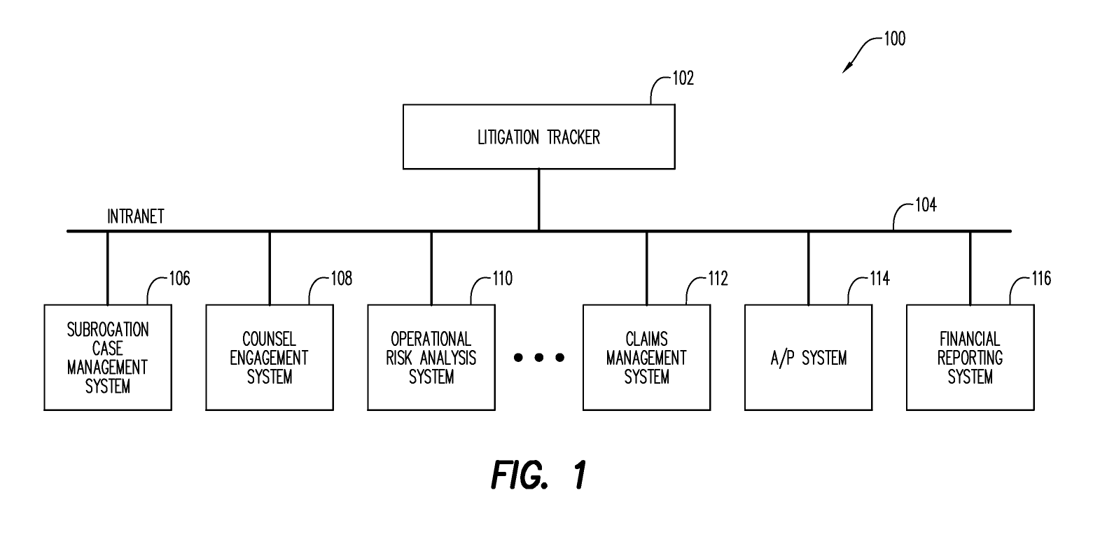

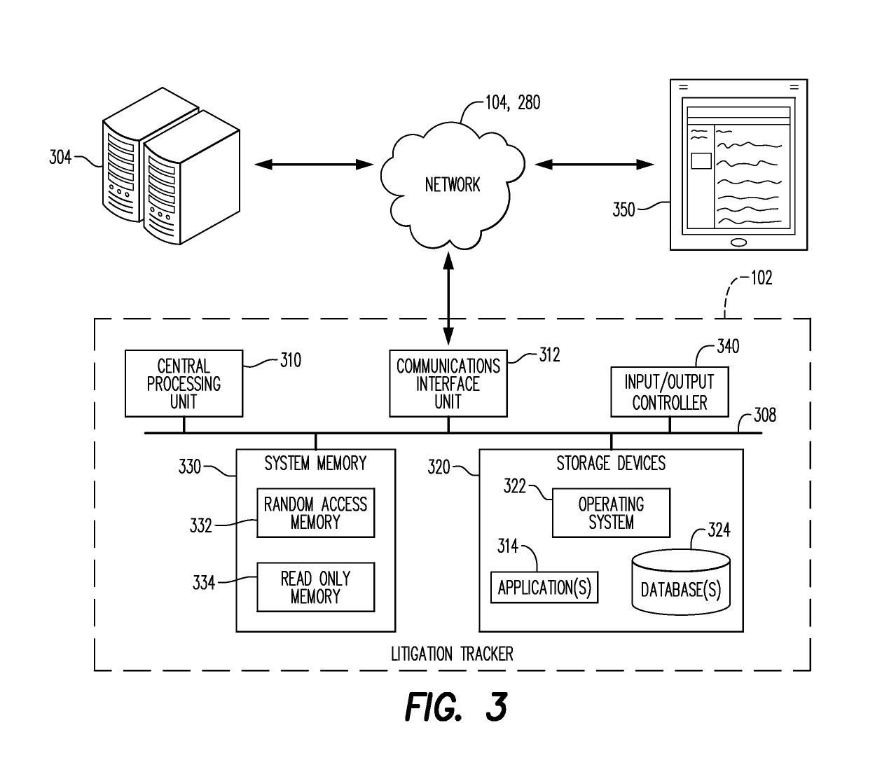

Features of some embodiments of the present invention will now be described by first referring to FIG. 1. FIG. 1 is a block diagram that illustrates aspects of an enterprise computer system 100 provided in a large insurance company in accordance with some embodiments of the invention. The enterprise computer system 100 may include a litigation tracker 102 provided in accordance with teachings of this disclosure. Details of the litigation tracker 102 will be described below, particularly with reference to FIGS. 3-23. The litigation tracker 102 itself may also be regarded as a computer system and may be constituted in part by dedicated computer hardware and/or by computer hardware shared with other aspects of the enterprise computer system. In addition to software aspects of the litigation tracker 102 described below, the litigation tracker 102 may in part rely on software resources (e.g., one or more operating systems) shared with other aspects of the enterprise computer system 100.

As shown in FIG. 1, the enterprise computer system 100 may include an intranet 104 and/or other data communication facilities to interconnect the litigation tracker 102 with other components of the enterprise computer system 100. These other components may include a subrogation case management system 106, an outside counsel engagement system 108, an operational risk analysis system 110, a claims management system 112, an accounts payable system 114 and a financial reporting system 116.

In the embodiment as illustrated in FIG. 1, the litigation tracker 102 is part of, and at least partially integrated with, other components of the enterprise computer system 100 of the insurance company. However, in other embodiments, the financial tracker 102 may be a centralized system that is partially or wholly independent of other computer systems of the insurance company. For example, it need not be the case that the litigation tracker 102 is interfaced to all or any one of the other system components shown in FIG. 1. In some embodiments, data transfer (in either direction) between the litigation tracker 102 and other computer systems of the insurance company may be at least partially a manual process.

It should also be understood that the enterprise computer system 100 may include other components besides those explicitly shown in FIG. 1. These other components may include, for example, an electronic mail system, an insurance policy billing system, an accounts receivable system, a human resources information system, etc. In some embodiments, the litigation tracker may be linked by data communications to one or more other components of the enterprise computer system 100 beyond those shown explicitly in FIG. 1.

Each or any combination of the components shown in FIG. 1 may be implemented as one or more software modules or objects, one or more specific-purpose processor elements, or as a combination thereof. Suitable software modules include, by way of example, an executable program, a function, a method call, a procedure, a routine or sub-routine, one or more processor-executable instructions, an object, or a data structure.

In some embodiments, all of the computer hardware facilities for the litigation tracker 102 and/or the enterprise computer system 100 may be maintained directly by the insurance company. However, in other embodiments, at least some portions of the litigation tracker 102 and/or the enterprise computer system 100 may be provided via what is known as “cloud computing”, e.g., via computing resources maintained at remote third-party server farms or the like.

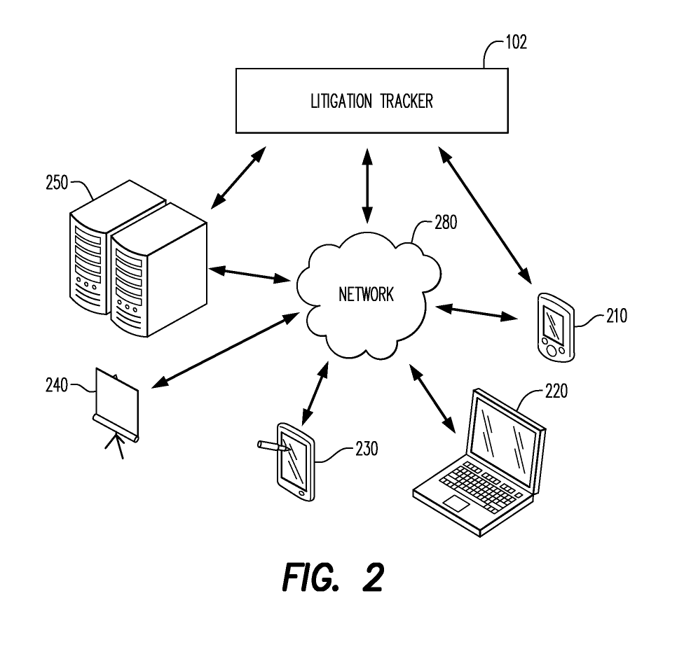

FIG. 2 illustrates access to the litigation tracker 102 using a myriad of different interfaces. These interfaces include a mobile device 210, a personal computer (laptop or desktop) 220, a pad or tablet computer 230, a thin client 240, and/or a mainframe or server computer 250. Each of these interfaces may access the litigation tracker 102 directly, or through a network 280 (which may at least partially coincide with the intranet 104 shown in FIG. 1).

FIG. 3 is a block diagram that shows some details of the litigation tracker 102. As will be understood from previous discussion herein, the litigation tracker 102 may interface with one or more other systems or system components (indicated by reference numeral 304) via a network 104 or 280.

In litigation tracker 102, a central processing unit or processor 310 executes instructions contained in programs, including for example application software programs 314, stored in storage devices 320. The application software programs 314 may provide functionality as described herein to implement the litigation tracker 102. Processor 310 may provide the central processing unit (CPU) functions of a computing device on one or more integrated circuits. As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

Storage devices 320 may include suitable media, such as optical or magnetic disks, fixed disks with magnetic storage (hard drives), tapes accessed by tape drives, and other storage media. Processor 310 communicates, such as through bus 308 and/or other data channels, with communications interface unit 312, storage devices 320, system memory 330, and input/output controller 340. System memory 330 may further include non-transitory computer-readable media such as a random access memory 332 and a read only memory 334. Random access memory 332 may store instructions in the form of computer code provided by an application 314 to implement teachings of the present invention. Litigation tracker 102 further includes an input/output controller 340 that may communicate with processor 310 to receive data from user inputs such as pointing devices, touch screens, and audio inputs, and may provide data to outputs, such as data to video drivers for formatting on displays, and data to audio devices. Such displays may include, for example, display devices that are included in interfaces referred to above and shown in FIG. 2.

Continuing to refer to FIG. 3, storage devices 320 are configured to exchange data with processor 310, and may store programs containing processor-executable instructions, and values of variables for use by such programs. Processor 310 is configured to access data from storage devices 320, which may include connecting to storage devices 320 to obtain or read data from the storage devices, or place or store data into the storage devices. Storage devices 320 may include local and network accessible mass storage devices. Storage devices 320 may include media for storing operating system 322 and mass storage devices such as storage 324 for storing one or more databases, including one or more databases for storing data relating to litigation cases brought against the insurance company.

Communications interface unit 312 may communicate via network 104 or 280 with other computer systems operated by the insurance company, such as with the system components shown in FIG. 1 and/or the interfaces shown in FIG. 2. In addition, the communications interface unit 312 may communicate with other servers, computer systems that function as remote sources of data, and with systems for implementing instructions output by processor 310. Litigation tracker 102 may also be configured in a distributed architecture, wherein databases and processors are housed in separate units or locations. Some such servers may perform primary processing functions and contain at a minimum, a RAM, a ROM, and a general controller or processor. In such an embodiment, each of these servers is attached to a communications hub or port that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SASTM, ATP, Bluetooth, GSM and TCP/IP. The network 104 or 280 may be or include wired or wireless local area networks and wide area networks, and may be implemented at least in part via communications between networks, including over the Internet.

One or more public cloud, private cloud, hybrid cloud and cloud-like networks may also be implemented, for example, to handle and conduct processing of one or more tasks, transactions, operations or processes as described herein as aspects of the present invention. Cloud based computing may be used herein to handle any one or more of the application, storage and connectivity requirements of the litigation tracker 102 and aspects of the present invention. For example, one or more private clouds may be implemented to handle litigation case data processing and storage in accordance with aspects of the present invention. Furthermore, any suitable data and communication protocols may be employed to accomplish the teachings of the present invention.

With reference still to FIG. 3, communications interface 312 is used for receiving and transmitting data related to litigation cases involving the insurance company. Processor 310 executes program instructions, such as program instructions provided by application(s) 314 to receive (via the communications interface 312) and to store (in database storage 324) the litigation case data. Examples of litigation case data stored in the database storage 324 will be described below.

Referring once again to FIG. 3, the litigation tracker 102 may communicate via the network 104 or 280 with a portable computing device 350, which represents one or more of the interfaces shown in FIG. 2. Continuing to refer to FIG. 3, the portable computer device may be, for example, a tablet computer of the type that includes a touch screen. The touch screen (or other display device of one or more of the interfaces) may from time to time display both the data entry forms and the reports described below.

FIG. 3A illustrates aspects of an application program 314 that controls operations of the litigation tracker 102. In addition to shared functions implemented in the application program 314, the application program 314 may also include a number of program modules, each of which is for use in connection with activities of a respective constituent department of the insurance company. In the example embodiment of the application program 314 shown in FIG. 3A, the program modules included in the application program 314 may include a module 362 for use by the group benefits department of the insurance company, a module 364 for use by the property and casualty (P&C) department of the insurance company, a module 366 for use by the claims department of the insurance company and a module 368 for use by the corporate law department of the insurance company. For each department, the respective module may provide a respective set of data entry forms and/or other functional features to accommodate the respective preferred operating practices of the departments. Thus, the litigation tracker 102 may provide the convenience of centralized data storage and management without imposing a one-size-fits-all administrative process on the various departments. Although four program modules are shown in the drawing, the number of program modules actually included in embodiments of the application program may be more or less than four, and may if desired by increased during the period of deployment of the litigation tracker 102.

In some embodiments, the litigation tracker application program 314 may be implemented using commercially available information management software which provides access to an underlying SQL database or the like.

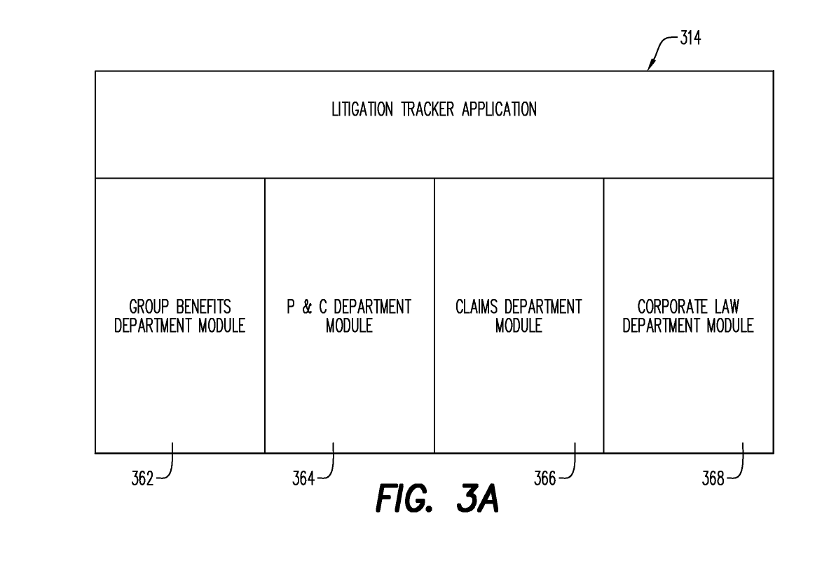

FIG. 4 is a high level flow chart that illustrates aspects of task-handling by the litigation tracker 102. The process steps described in connection with FIG. 4 may be generally applicable to some or all of the particular data management tasks that will be described with respect to subsequent drawings.

Block 402 represents commencement of a data management task. Block 404 represents receiving and/or entering (into litigation tracker 102) of data related to a litigation case involving the insurance company. This activity may involve, for example, user interaction with the computing device 350 or another interface illustrated in FIG. 2, and communication between the computing device 350 or interface and the litigation tracker 102.

Block 406 in FIG. 4 represents storage (e.g., in the database storage 324, FIG. 3) of the litigation case data entered or received at 404.

Block 408 indicates that the litigation tracker 102 makes the stored data accessible to one or more users of the litigation tracker and/or to other components of the enterprise computer system 100. The user's access to the data may be via one or more of the interfaces shown in FIG. 2, as discussed above. The access may include displaying of reports or other request data on display components of those interfaces.

Conventional techniques may be employed to manage and/or limit access to the litigation case data stored in the litigation tracker 102 so that only authorized access occurs. For example, the litigation tracker 102 may limit access to the data it stores based on subject area and/or the role that has been assigned to the user in connection with the litigation tracker 102. Some administrators and/or managerial individuals may have unlimited access to the data. On the other hand, some individuals, such as litigation case managers or paralegals, may have limited access, such as access only to data for cases they have been assigned to manage or work on. In some embodiments, for example, notes related to settlement negotiations may be treated by the litigation tracker 102 as confidential, and access to such notes may be limited to the litigation manager for the particular litigation case, and the chain of management to which the litigation manager reports.

Block 410 represents generation of reports from the stored litigation case data by the litigation tracker 102. Again, user privileges to define and/or access reports may be managed according to conventional techniques to prevent unauthorized access from occurring.

It should be understood that one or more of the process steps shown in FIG. 4 may occur with respect to some or all of the data management tasks hereinafter described.

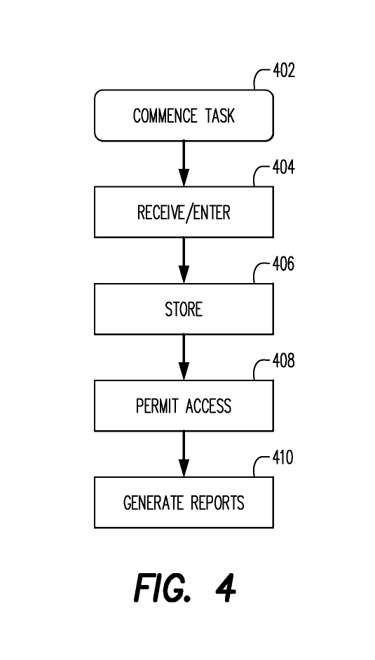

FIG. 5 is a more detailed, and life-cycle-oriented, flow chart illustration of operations of the litigation tracker 102 and of the corresponding application program 314. The process illustrated in FIG. 5 relates only to litigation cases to be defended by the insurance company; handling of subpoenas served on the insurance company will be discussed at a later stage of this disclosure in conjunction with a flow chart that is contained in a subsequent drawing.

The process of FIG. 5 commences at 502 with service of a legal complaint or the like on the insurance company (or perhaps alternatively with receipt by the insurance company of a complaint previously served on one of the company's policyholders). The receipt of litigation papers launches an intake process, which is represented by block 504 in FIG. 5. Block 504 involves interactions by one or more employees of the insurance company with the litigation tracker 102.

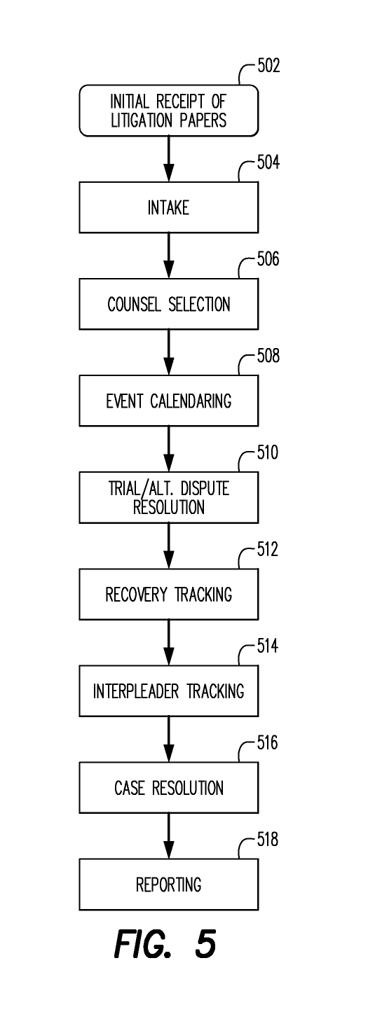

One part of the intake process for a litigation case may involve a supervisory manager assigning the case to a litigation manager. FIG. 6 is a workload dashboard screen shot that may be displayed by the litigation tracker 102 to aid the supervisory manager in deciding upon which litigation manager is to be assigned the new case. For example, a segment 602 of the dashboard may contain a bar chart that displays the case loads of the available litigation managers. Segment 604 of the dashboard may contain a bar chart that indicates closed cases by litigation manager. Other bar charts may also be provided to indicate other information about caseloads and case statuses for the department as a whole.

In some embodiments, the litigation tracker 102 may generate an intake sheet (not shown), which may be printed out and then filled out by the supervisory manager to indicate assignment of the new case to a litigation manager selected by the supervisory manager. The filled out sheet may be passed to the selected litigation manager and then used to enter into the litigation tracker 102 information concerning the assignment of the case to the selected litigation manager. A paralegal in the department may be assigned to the case at the same time to assist the litigation manager.

In other embodiments, the litigation tracker 102 may provide a data entry form (not shown) to permit entry of the name of the selected litigation manager into a record for the litigation case, and the litigation tracker 102 may automatically dispatch an electronic mail message to the selected litigation manager to inform him/her that the new case has been assigned to him/her.

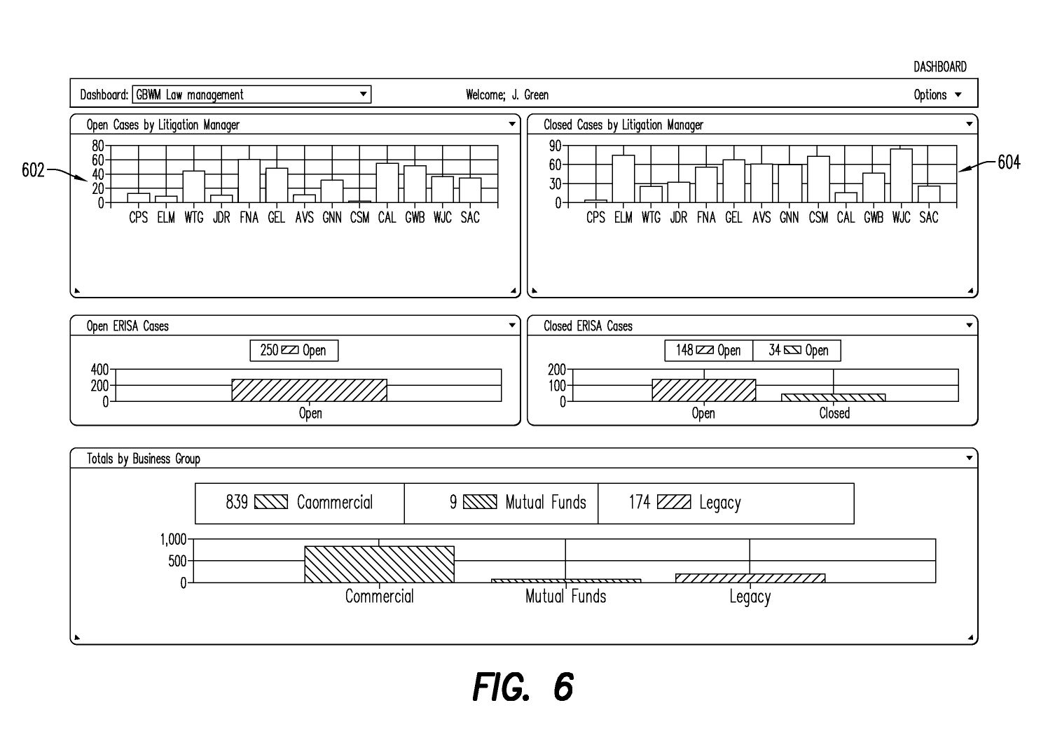

According to another aspect of the intake process (block 504, FIG. 5), the litigation tracker may provide a data entry form as shown in FIG. 7. This form may permit administrative information to be input relating to the new case, including expense coding at 702 and document retention coding at 704. In some embodiments, drop down menus may be associated with the data fields at 702 and 704 to aid in entry of the coding information.

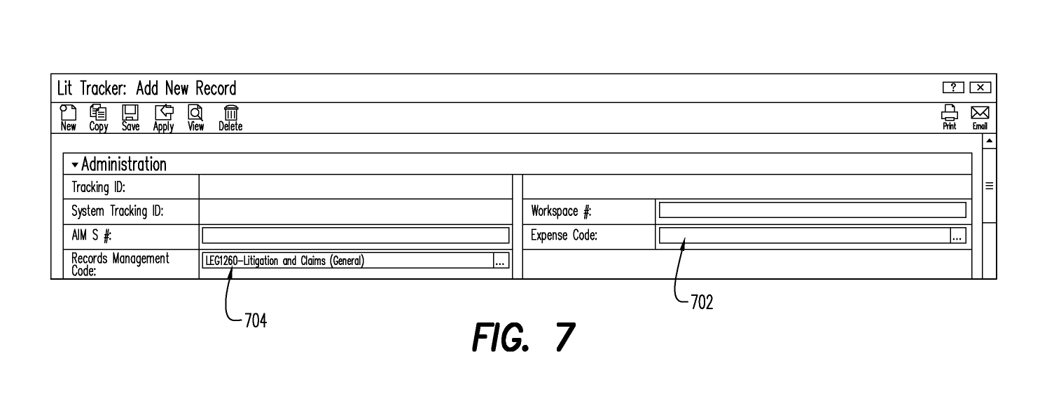

In accordance with another aspect of the intake process, the litigation tracker 102 may provide a further data entry form as shown in FIG. 8. A user may select a matter type at 802, and may designate the relevant department of the insurance company at 803. Based on the matter type and department selected, a particular program module of the litigation tracker 102 may be invoked, leading to selection of a particular set of data entry fields to be displayed in this form.

The purpose of the data entry form shown in FIG. 8 is to permit entry into the litigation tracker 102 of general information about the new case. This may include, for example, a brief summary of the nature of the case (to be entered at 804) and information about the manner of service at 806.

The data entry form as shown in FIG. 8 may be provided by a particular program module of litigation tracker 102, intended for use by a particular department of the insurance company. If a different department were selected for the data entry form, a different program module may be invoked, causing the litigation tracker 102 to display a corresponding data entry form in a different format, such as that shown in FIG. 8A. In comparing the data entry forms of FIGS. 8 and 8A with each other, it will be observed that the data entry form of FIG. 8A presents a somewhat different format and array of data entry fields relative to the form of FIG. 8, and includes data entry fields that are not present in the form of FIG. 8. For example, the data entry form in FIG. 8A includes data entry fields for the particular county or court where the case is pending (reference numeral 852) and for the case docket number assigned by the court (reference numeral 854).

With the different data entry forms produced by the respective program modules for different departments of the insurance company, the particular preferred litigation handling processes of each department are accommodated.

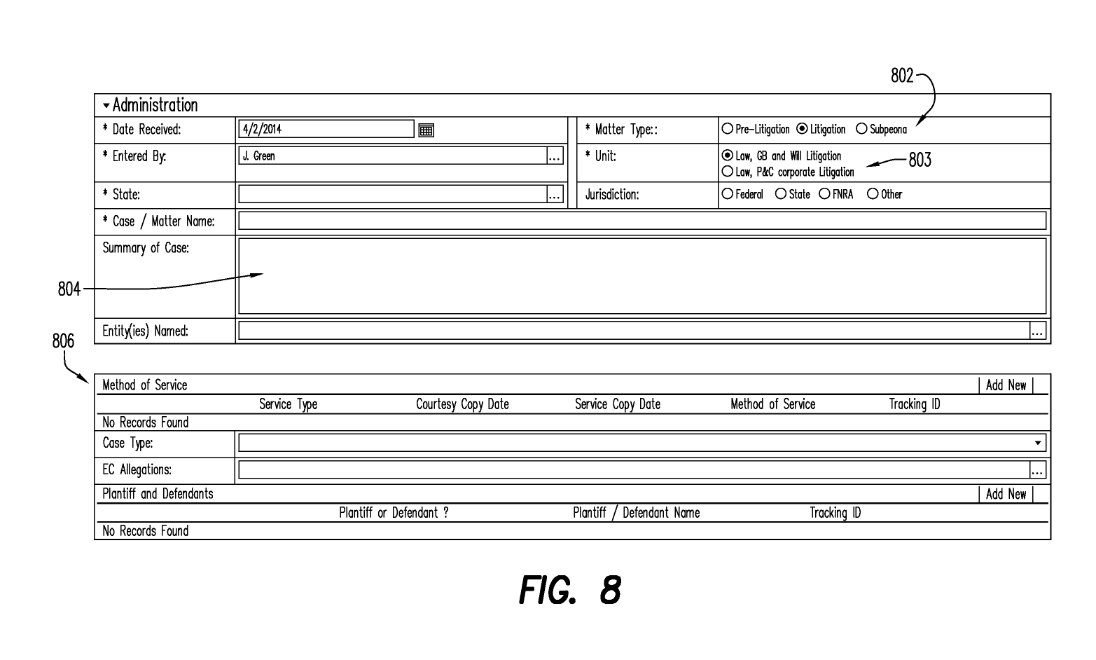

Still further with respect to the intake process (block 504, FIG. 5), FIG. 9 shows another data entry form that may be provided by the litigation tracker 102. The particular data entry form in FIG. 9 may be considered a subform that allows entry of information concerning the relevant insurance policy (form section 902) and concerning the relevant claim (form section 904).

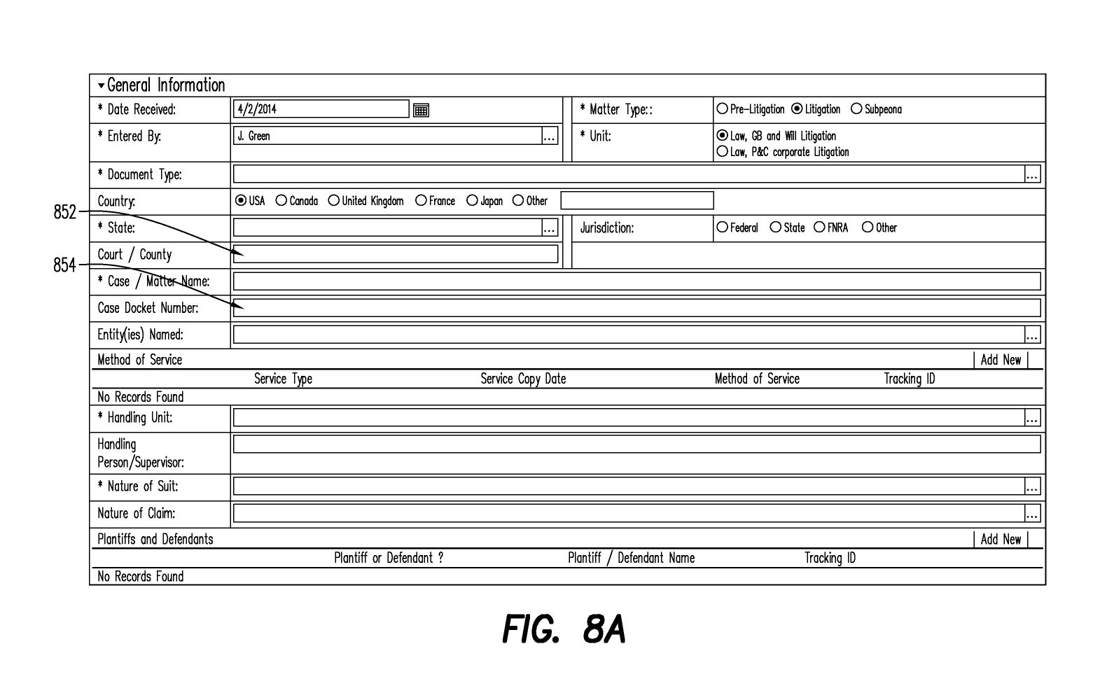

Another subform related to the intake process is shown in FIG. 10. The purpose of this data entry form/subform is to aid the insurance company in its compliance with any relevant requirement that the policyholder be notified that the court action has been instituted. The form in FIG. 10 allows the user to enter information that is relevant to the notification requirement, if it exists.

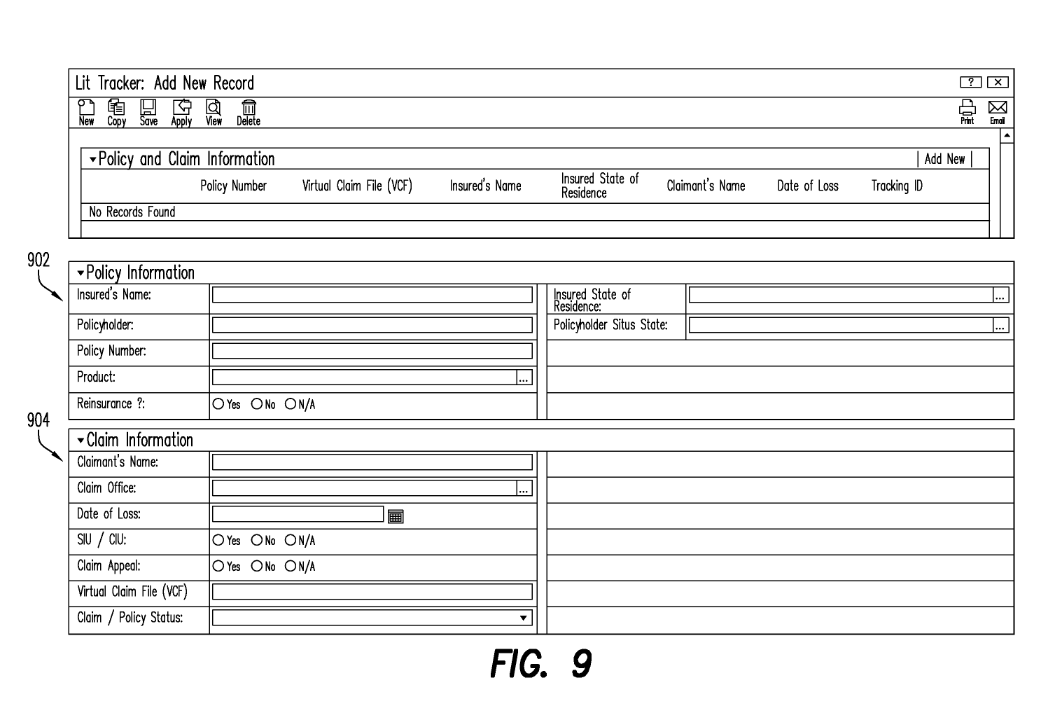

The data entry form shown in FIG. 11 is also related to the intake process. This data entry form contains data entry fields that permit entry of information that identifies the line of business as well as the business segment for the insurance policy from which the litigation case arises. For example, identification of the line of business may be entered into the data entry fields at 1102, 1104, and the business segment can be identified by using data entry field 1106.

One or more of the data entry forms as described above in connection with FIGS. 6-11 and/or block 504 in FIG. 5 may in addition include a comment section/data field (not shown). The comment section/data field may support entry of unlimited free form text to allow the user to annotate and/or add comments to the case intake data entered into other fields of the data entry forms. The litigation tracker 102 may attach the free form text to the case entry for the respective litigation case.

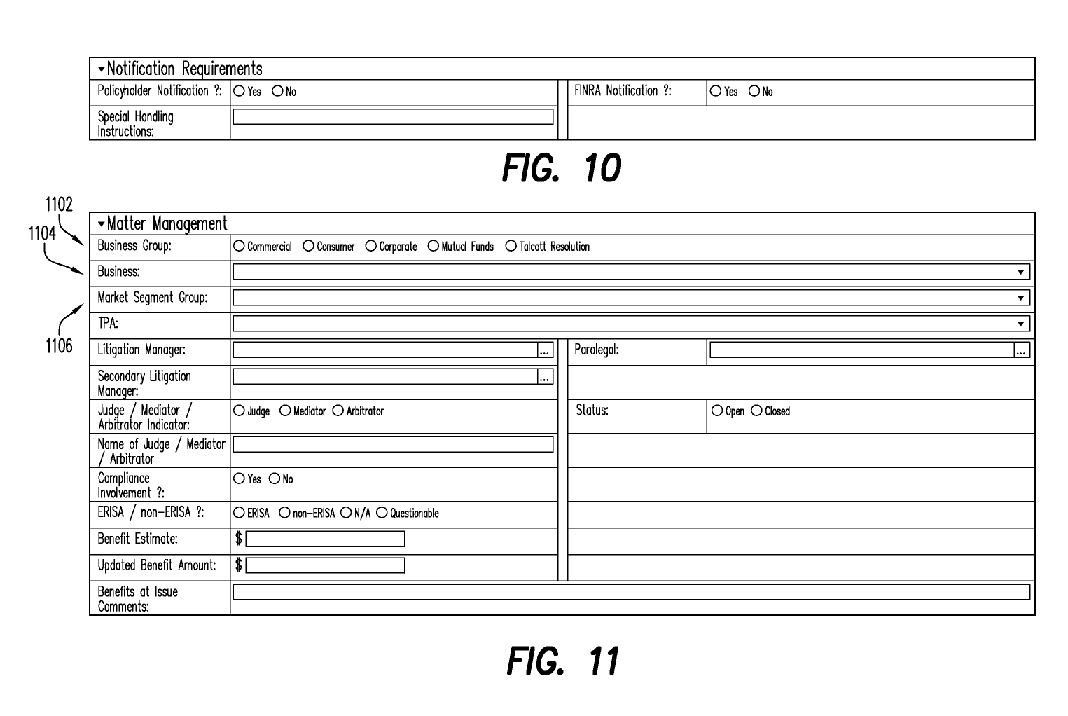

Referring again to FIG. 5, block 506 may follow block 504. At block 506, outside litigation counsel may be selected by the litigation manager (possibly in consultation with the supervisory manager). This process step may also involve interaction by the litigation manager with the litigation tracker 102. For example, FIG. 12 shows a data entry form that permits entry of information that identifies the outside counsel selected to represent the insurance company and/or the insured (data entry field 1202). In the same data entry form, at data entry fields 1204, the user/litigation manager may enter information that identifies the plaintiff's counsel.

In some embodiments, the litigation manager may utilize another computerized system to actually engage the outside counsel (e.g., an outside counsel engagement system 112 as shown in FIG. 1), and may use the data entry form in FIG. 12 only to store data in the litigation tracker 102 to reflect actions the litigation manager has taken via the outside counsel engagement system 112. In other embodiments, entry of counsel selection data into the litigation tracker 102 may cause the litigation tracker 102 to interact directly with the outside counsel engagement system 112 to trigger the outside counsel engagement system 112 to initiate a process to engage the selected counsel, to communicate the engagement automatically to the selected counsel from the outside counsel engagement system 112, etc. In still other embodiments, the litigation tracker 102 and the outside counsel engagement system 112 may be at least partially integrated with each other as an application program running on the enterprise computer system 100.

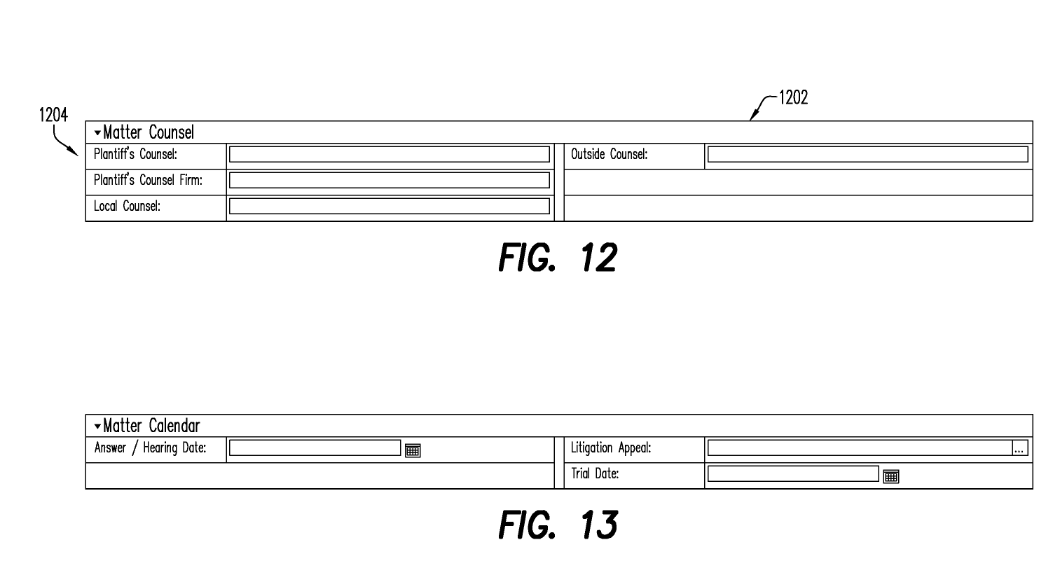

Again referring to FIG. 5, block 508 may follow block 506. At block 508, users of the litigation tracker 102 may calendar events expected or scheduled to occur in the litigation case by entering appropriate information in the litigation tracker 102. An example data entry form provided by the litigation tracker 102 for this purpose is shown in FIG. 13. Among events that may be calendared and tracked (using this or similar data entry forms) are an answer due date, a hearing date, a trial date, an appeal date, and status of trial and/or appeal.

FIG. 13A shows an alternative data entry form that may be provided by the litigation tracker 102 for entry of calendaring information. In some embodiments the form shown in FIG. 13 may be provided by one program module of the litigation tracker 102 for use by one department of the insurance company, while the form shown in FIG. 13A may be provided by another program module of the litigation tracker 102 for use by another department of the insurance company. As seen from the data entry form in FIG. 13A, calendaring activities supported by the litigation tracker 102 may also include entering and tracking discovery deadlines, and scheduled dates for motions and status conferences. In other embodiments, the dates for particular depositions may also be calendared and tracked.

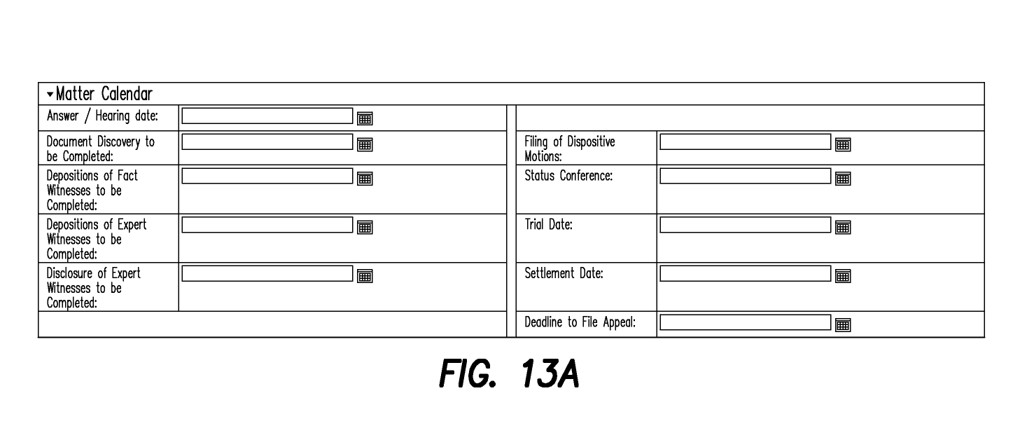

Reference is again made to FIG. 5. In the process of FIG. 5, block 510 may follow block 508. Block 510 represents actions taken with respect to scheduled or planned trial or alternative dispute resolution (mediation or arbitration) proceedings for the litigation case. For example, the data entry form shown in FIG. 14 may be used to enter the name of the judge, mediator or arbitrator who is or will be involved in the trial or other proceedings for the litigation case (see data entry fields 1402 in FIG. 14). By tracking the name of the judge/mediator/arbitrator involved in this particular case, it may be possible for litigation managers to share information with each other if the same judge/mediator/arbitrator is involved in subsequent litigation cases defended by the insurance company.

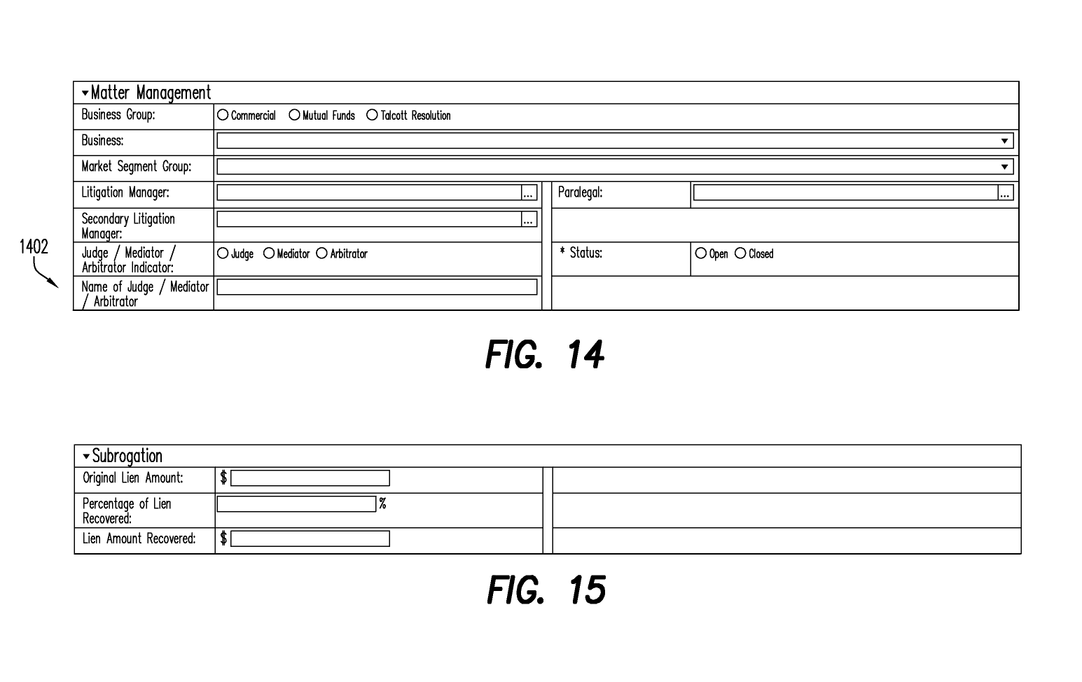

Another block shown in FIG. 5 is block 512. At block 512, a user or users may interact with the litigation tracker 102 to store and track information related to dollar amounts recovered by the insurance company to offset some or all of the costs incurred or payments made by the insurance company with respect to the litigation case. In general, there may be three avenues by which the insurance company may obtain a full or partial recovery of costs incurred and/or payment made: (1) pursuant to a reinsurance agreement, (2) via a subrogation claim, and (3) via a claim against the plaintiff for a frivolously asserted court action. For example, FIG. 15 shows a data entry form by which a user of the litigation tracker 102 may enter data relating to potential and actually realized recovery via a subrogation claim. In some embodiments, some of the data concerning subrogation recovery or potential recovery that can be entered via the data entry form of FIG. 15 may alternatively be fed directly to the litigation tracker 102 (i.e., without user entry of the data into the litigation tracker 102) from the subrogation case management system 106 shown in FIG. 1.

In some embodiments, the data entry form of FIG. 15 may further include a data field or fields (not shown) in which a user may enter an estimate of a monetary amount that the insurance company is likely to recover via subrogation in connection with the litigation case. In some embodiments, the litigation tracker 102 may itself automatically calculate and store an estimate of an anticipated recovery amount with respect to a potential subrogation claim by the insurance company. Such an automated estimate may, for example, be based on information input into the litigation tracker 102 by one or more users and/or data received by the litigation tracker 102 from one or more other computer systems operated by the insurance company. In some embodiments, the computer processor 310 (FIG. 3) may be programmed to implement a predictive model to generate the estimate of the amount to be recovered via subrogation. The predictive model may be based on data from previous litigation cases that the litigation tracker 102 stores. In some embodiments, the litigation tracker 102 may compare and track the actual monetary amount recovered with a user-entered or automatically-generated estimated recovery amount. As subsequent developments occur in the litigation case, a user and/or the litigation tracker 102 itself may update an estimated recovery amount.

Continuing to discuss block 512 of FIG. 5, the litigation tracker 102 may also provide other data entry forms (not shown) by which users can enter into the litigation tracker 102 data indicative of amounts recovered via reinsurance or by a successful claim by the insurance company that the plaintiff had brought a frivolous action.

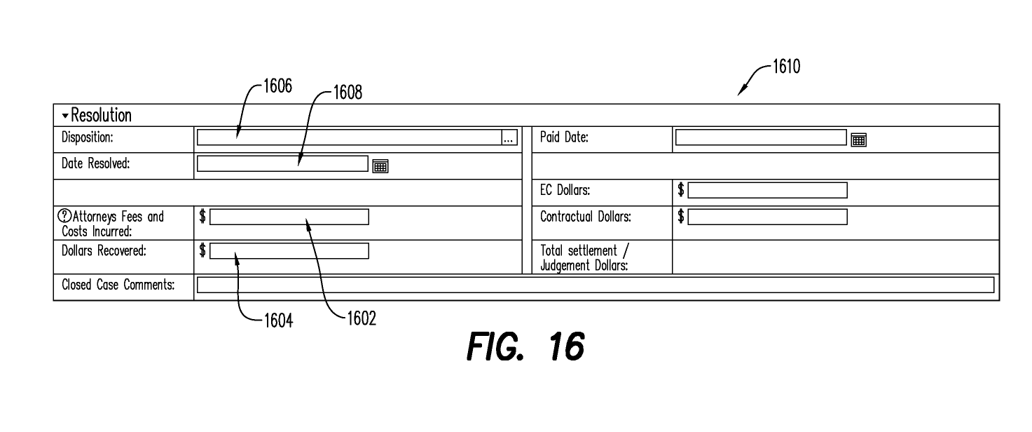

FIG. 5 also shows a block 514. At block 514, a user of the litigation tracker 102 may input data regarding an interpleader action instituted by the insurance company in connection with the litigation case. As is understood by those who are skilled in the art, in some situations an insurer may concede that a payment of policy benefits is due, but there may be two or more conflicting claims to the benefits. In such situations, in many states, there is statutory authority for the insurer to pay the benefits into court and to interplead the claimants to the benefits so that the controversy between the claimants can be resolved by the court without further involvement by the insurer. It may also be the case that the insurer's costs and attorneys' fees expended in initiating the interpleader action may be taken from the amount of the benefits payable from the relevant insurance contract, rather than forming an additional charge to the insurer. Accordingly, for an interpleader situation, the litigation tracker 102 may provide a data entry form like that shown in FIG. 16. In the data entry form of FIG. 16, data entry fields 1602 and 1604 are provided for entry of costs incurred and amount recovered, respectively, in connection with an interpleader.

Referring again to FIG. 5, another stage of the process is represented by block 516. At 516, a user of the litigation tracker 102 may enter information relating to the resolution of the litigation case. The data entry form in FIG. 16 may be provided by the litigation tracker 102 for this purpose as well as for the above-discussed purpose of interpleader tracking. For example, and referring again to FIG. 16, data entry fields 1606 and 1608 may be provided for entering the nature of the disposition of the case, and the date of disposition, respectively. The right-hand section (reference numeral 1610) of the data entry form includes data entry fields for entering information about amounts paid by the insurance company in connection with the litigation case. The amounts paid may be broken down between amounts paid pursuant to the insurer's contractual obligations, and amounts awarded or paid on an extra-contractual basis.

FIG. 5 also shows a block 518. At block 518, the litigation tracker 102 may produce reports derived from data stored in the litigation tracker 102. At a subsequent stage of this disclosure, there will be discussion of example reports that may be generated by the litigation tracker 102 in accordance with some embodiments.

In a pro forma manner, the process stages are depicted sequentially in FIG. 5, but in practice, the order of the process stages may be quite different from the order depicted in the drawing. For example, reporting may occur virtually at any time in the process relative to a given litigation case. Moreover, some of the process stages, such as event calendaring, may occur repeatedly over the course of management of a single litigation case. Still further, the depiction of the process in FIG. 5 relates to only one litigation case, whereas the litigation tracker may be used to simultaneously manage hundreds or thousands of litigation cases. Consequently, the litigation tracker may be utilized virtually simultaneously for managing different stages of various litigation cases.

The process stages illustrated in FIG. 5 may be implemented in some embodiments of the invention, and/or by one or more departments of an insurance company. In other embodiments, or for the purposes of some departments of the insurance company, it may be found that not all of the process stages of FIG. 5 may be needed. For example, some departments may find that recovery tracking and/or interpleader tracking may not be required. For such departments, the litigation tracker 102 or an appropriate program module thereof may be operative to omit the respective data entry forms for the process stages that are irrelevant to the department in question.

As an alternative to at least some of the manual data entry facilitated by the data entry forms shown in FIGS. 7-16, at least some litigation case data may be transmitted to the litigation tracker 102 from one or more other computer systems operated by the insurance company. For example, in lieu of filling out the data entry form of FIG. 12, a user (e.g., a litigation manager) may interact with the above-mentioned counsel engagement system 108 (FIG. 1) by entering information regarding plaintiff's counsel and regarding defense counsel selected by the user. The user's interaction with the counsel engagement system 108 may lead to engagement of the selected defense counsel by the insurance company. The counsel engagement system may also transmit the relevant counsel information to the litigation tracker 102 for storing by the litigation tracker 102 in association with other data about the particular litigation case.

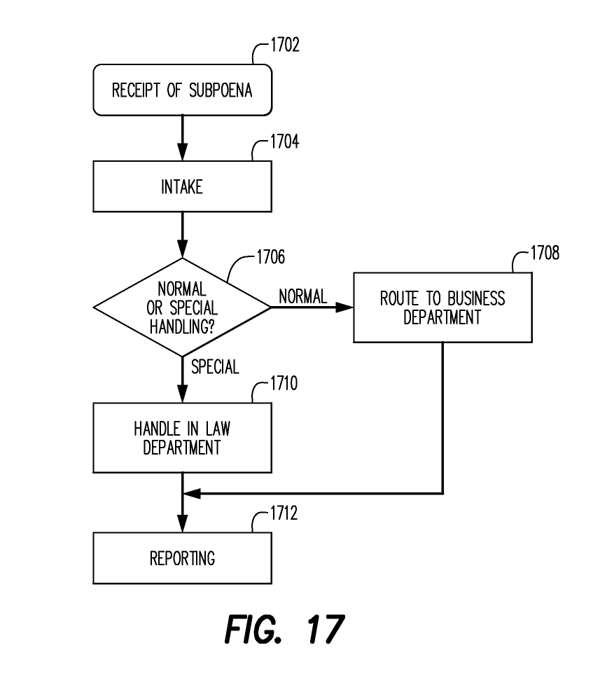

FIG. 17 is a flow chart that illustrates a process that may be performed to handle a subpoena with support from the litigation tracker 102.

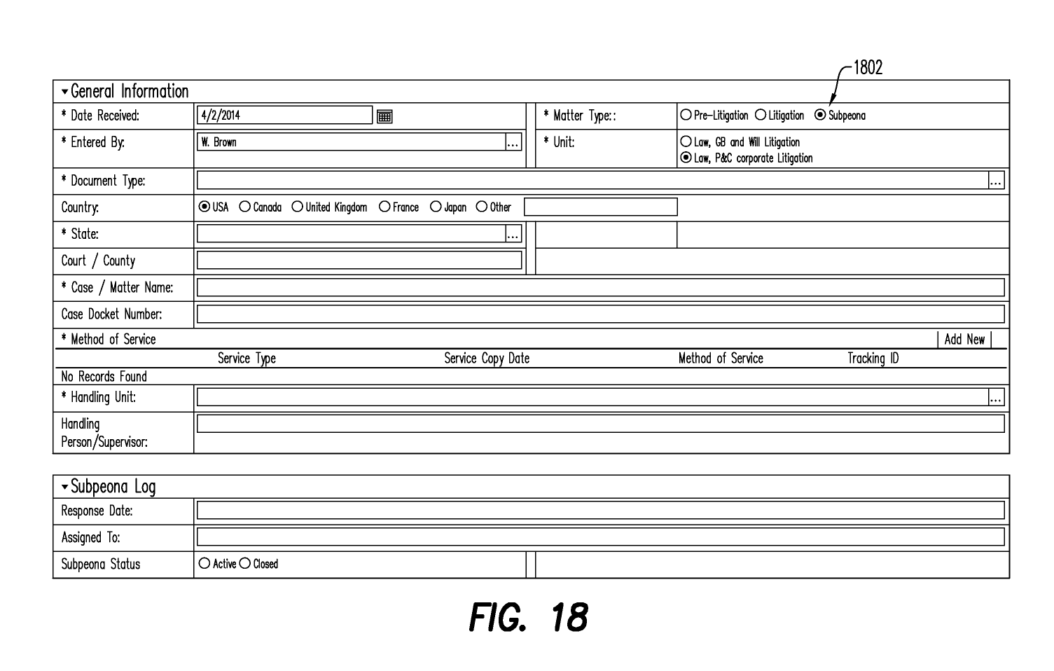

The process of FIG. 17 starts at 1702 with service of a subpoena on the insurance company. The receipt of the subpoena launches an intake process, which is represented by block 1704 in FIG. 17. Block 1704 involves interactions by one or more employees of the insurance company with the litigation tracker 102. For example, in connection with block 1704, a user of the litigation tracker 102 may enter data concerning the subpoena using a data entry form provided by the litigation tracker 102. An example of such a data entry form is shown in FIG. 18, and may be displayed on the portable computing device 350 (FIG. 3) or on the display component of one of the interfaces shown in FIG. 2. Selection by the user of the “Subpoena” radio button (reference numeral 1802 in FIG. 18) causes the litigation tracker 102 to present, in the data entry form, suitable data entry fields for entering the subpoena into the litigation tracker 102.

Referring again to FIG. 17, a decision block 1706 may follow block 1704 in the process of FIG. 17. At decision block 1706, it is determined whether the subpoena will be processed with normal handling or with special handling. For example, subpoenas issued in a court action between private parties may be assigned to normal handling, whereas subpoenas issued by a grand jury, by a government regulatory body, or by the federal Internal Revenue Service may be assigned for special handling.

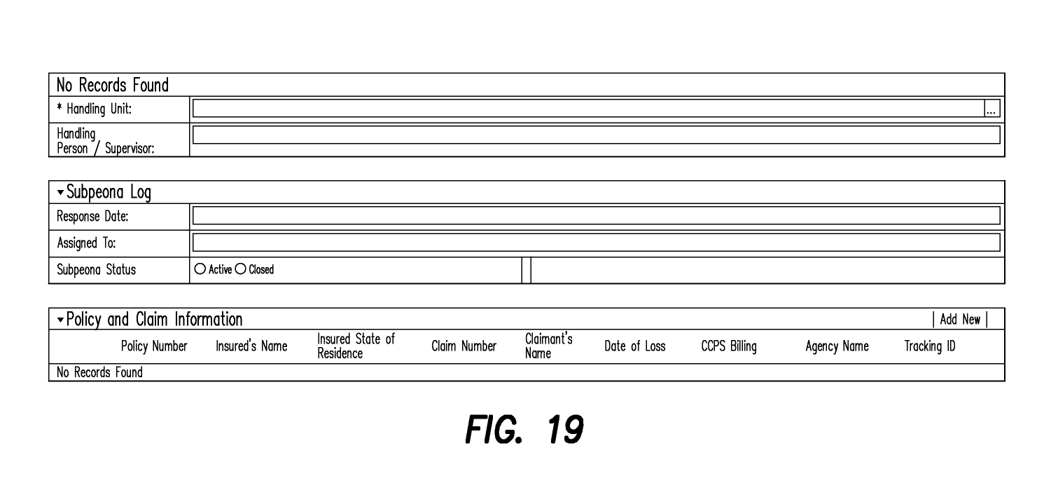

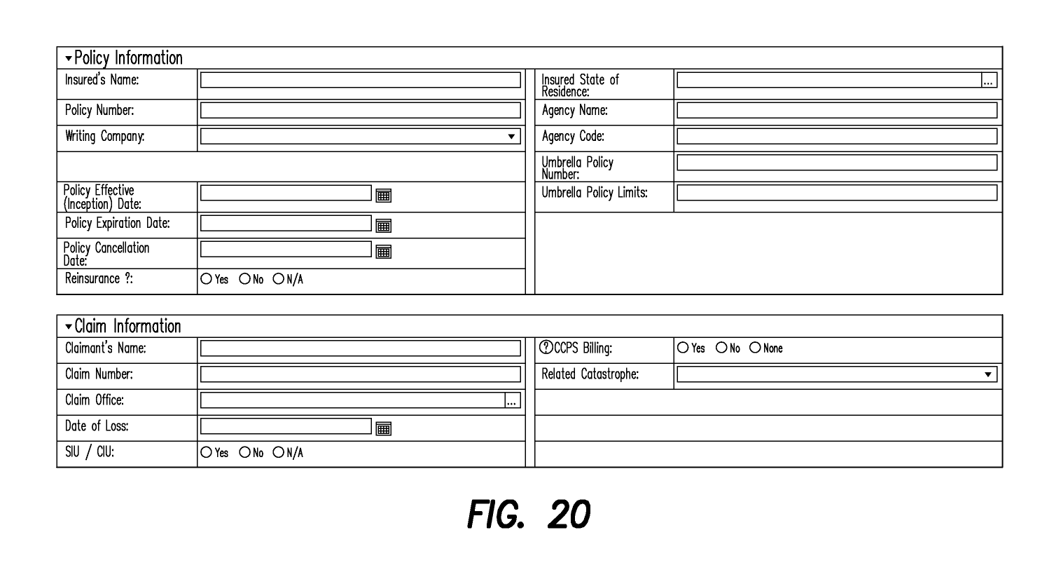

If it is determined at decision block 1706 that the subpoena is to receive normal handling, then the process of FIG. 17 may advance from decision block 1706 to block 1708. At block 1708, the subpoena may be assigned from the insurance company's law department to the relevant business department of the insurance company for handling by the latter department. In connection with such an assignment, a user of the litigation tracker 102 may enter further data about the subpoena into the litigation tracker 102 by using data entry forms provided by the litigation tracker 102, such as example data entry forms as shown in FIGS. 19 and 20. In addition to the general information about the subpoena that can be entered via the data entry form in FIG. 19, the user is able to enter policy-related and claim-related information about the subpoena via the data entry form in FIG. 20. The data entered via the data entry forms in FIGS. 19 and 20 may allow the litigation tracker 102 to track subpoenas by line of business and by date of transfer to the relevant department.

Considering again decision block 1706 in FIG. 17, if it is determined at that decision block that the subpoena is to be accorded special handling, then the process of FIG. 17 may advance from decision block 1706 to block 1710. At block 1710, the subpoena may be retained in the law department of the insurance company for special handling.

FIG. 17 also shows a block 1712, which represents generation of reports by the litigation tracker 102 with respect to the insurance company's receipt and handling of subpoenas.

In some embodiments, the decision block 1706 represents decision making by an individual user of the litigation tracker 102 (for example, the user may be a supervisory manager). In other embodiments, the litigation tracker 102 may be programmed to automatically make the subpoena handling determination of decision block 1706.

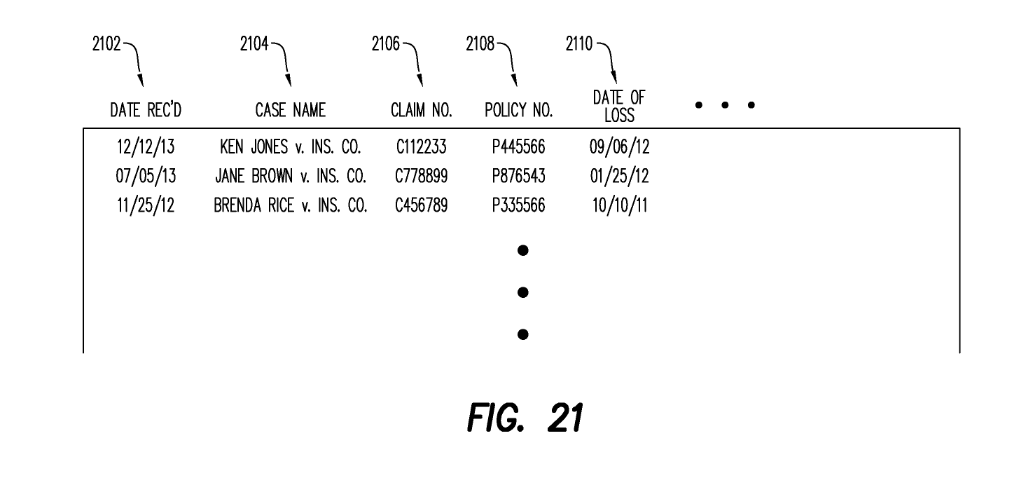

FIGS. 21-23 are simplified examples of reports that may be generated by the litigation tracker 102 from the litigation case data entered into the litigation tracker 102 in connection with the process of FIG. 5. The litigation tracker 102 may, for example, generate these reports in response to instructions from users and/or administrators of the litigation tracker 102. The reports may be displayed on display components of devices interfaced to the litigation tracker 102, and/or may be printed on paper (by a printer which is not shown). The litigation tracker may also generate other reports based on the subpoena-related data entered into the litigation tracker 102 in connection with the process of FIG. 17.

FIG. 21 illustrates a simplified example report concerning pending litigation cases for a given department of the insurance company. Each row in the report represents a respective pending litigation case. The columns as shown in FIG. 21 include: (a) a column 2102 that indicates the date that the litigation papers were initially received by the insurance company; (b) a column 2104 that indicates the name of the litigation case; (c) a column 2106 that indicates the relevant claim number; (d) a column 2108 that indicates the relevant policy number; and (e) a column 2110 that indicates the date on which the relevant loss event occurred.

To simplify the drawing, only five columns are shown. However, in practical embodiments of the invention, the number of columns may be greater than five (or less). The following are examples of columns that may also be included in the report in addition to or instead of some or all of the columns shown in FIG. 21: (a) type of document served; (b) nature of suit; (c) name of assigned litigation manager; (d) market segment for the relevant policy; (e) claimant's name; (f) insured's name; (g) policy effective date; (h) policy expiration date; and (i) policy number. Although only three rows of information are depicted in FIG. 21, in practice a report of this type may contain many more rows.

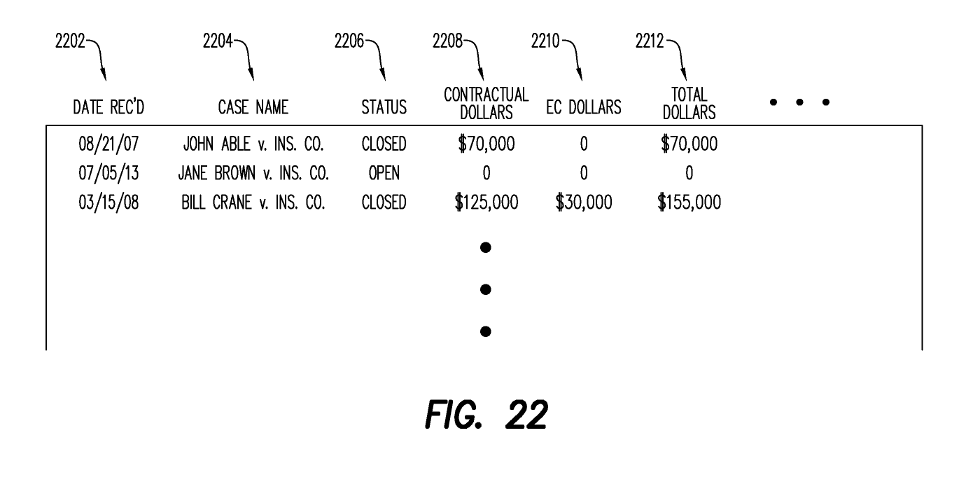

FIG. 22 illustrates a simplified example report that represents a “snapshot” (view of current information) relevant to the potential for reinsurance claims with respect to claims that have been or are now pending for a given department of the insurance company. Each row in the report represents a respective litigation case, of which some may be pending and some may be closed. The columns as shown in FIG. 22 include: (a) a column 2202 that indicates the date that the litigation papers were initially received by the insurance company; (b) a column 2204 that indicates the name of the litigation case; (c) a column 2206 that indicates the status (open or closed) of the litigation case; (d) a column 2208 that indicates the dollar amount (if any) that the insurance company has paid out in the case on a contractual basis; (e) a column 2210 that indicates the dollar amount (if any) that the insurance company has paid out in the case on an extra-contractual basis; and (f) a column 2212 of total dollars (sum of columns 2208 and 2210) paid out by the insurance company for the litigation case.

To simplify the drawing, only six columns are shown in FIG. 22. However, in practical embodiments of the invention, the number of columns may be greater than six (or less). The following are examples of columns that may also be included in the report in addition to or instead of some or all of the columns shown in FIG. 22: (a) estimated benefit amount; (b) update of estimated benefit amount; (c) market segment group; (d) line of business; (e) case type; (f) indication of ERISA vs. non-ERISA; (g) jurisdiction; (h) state; (i) name of assigned litigation manager; (j) date of payment by insurance company; (k) date of resolution of the litigation case; (1) type of disposition of the litigation case; (m) insured's name; (n) policyholder's name; (o) policy number; (p) claim office; and (q) type of product. Although only three rows of information are depicted in FIG. 22, in practice a report of this type may contain many more rows.

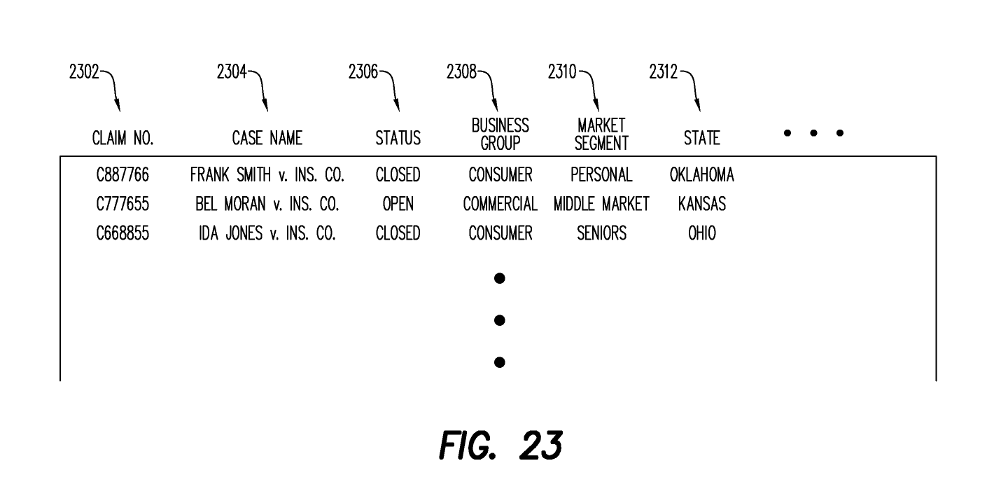

FIG. 23 illustrates a simplified example report that presents a “scorecard” for litigation cases that were open at some point during a certain period of time (say a calendar year). Each row in the report represents a respective litigation case. The columns as shown in FIG. 23 include (a) a column 2302 that indicates the relevant claim number; (b) a column 2304 that indicates the name of the litigation case; (c) a column 2306 that indicates the status (open or closed) of the litigation case; (d) a column 2308 that indicates the business group that sold the relevant policy; (e) a column 2310 that indicates the market segment into which the relevant policy was sold; and (f) a column 2312 that indicates the geographical state in which the litigation case is pending.

To simplify the drawing, only six columns are shown in FIG. 23. However, in practical embodiments of the invention, the number of columns may be greater than six (or less). The following are examples of columns that may also be included in the snapshot report in addition to or instead of some or all of the columns shown in FIG. 23: (a) the date the litigation papers were initially received by the insurance company; (b) the date the litigation case was resolved (if the case is no longer pending); (c) the name of the assigned litigation manager; (d) the nature of the claim; (e) the insured's name; and (f) number of the relevant insurance policy. Although only three rows of information are depicted in FIG. 23, in practice a report of this type may contain many more rows.

The centralized nature of the litigation case data storage provided by the litigation tracker 102 makes it quite convenient for authorized users to call up standard or custom reports based upon the stored data. The reports can also be generated quite rapidly. Monthly and quarterly reports can be generated quite readily by the litigation tracker 102. Reports can be keyed from any data field that the authorized user chooses to select, and the fields (columns) to be included in the report can be selected arbitrarily by the user to generate a custom report.

In addition to the types of reports already described, the litigation tracker 102 can readily generate reports of (a) all open litigation cases (e.g., over all or by department); (b) all closed cases (e.g., cases closed within a particular calendar period); (c) all new cases (e.g., within a particular calendar period); (d) all amounts spent in paying settlements and judgments (e.g., by department); (e) the total of current exposure to claims for extra-contractual damages (e.g., by department); etc.

The centralized nature of the litigation case data storage in the litigation tracker 102 also facilitates management of access privileges and security for the data.

The above disclosure has included descriptions of data entry fields to facilitate manual entry of data into the litigation tracker 102. However, the present invention also contemplates that, in some embodiments, a considerable portion of the litigation case data to be stored in the litigation tracker 102 may be automatically loaded therein from other computers. For example, insurance policy data that is relevant to a litigation case may be downloaded to the litigation tracker 102 from a policy information data warehouse (not shown). Also, information from an outside counsel engagement system 108 (FIG. 1) may also be transferred to the litigation tracker 102 and/or information can be transferred from the litigation tracker 102 to the outside counsel engagement system 108.

The litigation tracker 102 may also be configured to transfer data concerning the costs related to litigation cases to other systems, such as the operational risk analysis system 110, to facilitate analysis of the financial risks attached to various lines of business, market sectors, etc. For example, the litigation tracker 102 may transfer, to the operational risk analysis system 110, upon disposition of a litigation case, a sum of an amount paid in settlement by the insurance company and the amount of defense counsel's fees. This total amount may be connected with a specific loss event for analytical purposes by the operational risk analysis system 110.

Along the same lines, data regarding amounts paid or spent with respect to the litigation cases may also be transferred from the litigation tracker 102 to accounting and/or financial reporting systems (e.g., the financial reporting system 116 shown in FIG. 1). In addition, the litigation tracker 102 and the subrogation case management system 106 (FIG. 1) may exchange relevant data with each other.

In some embodiments of the litigation tracker 102, the data stored therein may relate to a large volume of litigation cases, including significant amounts paid in settlement, and millions of dollars in fees paid to defense counsel.

The portable computing device 350 (FIG. 3) and/or any other interface having a display device for displaying screen shots or data entry forms provided by the litigation tracker 102 may be considered part of the litigation tracker 102 or part of a computer system that includes the litigation tracker 102.

The process descriptions and flow charts contained herein should not be considered to imply a fixed order for performing process steps. Rather, process steps may be performed in any order that is practicable.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A computer system for tracking litigation cases at an insurance company, the computer system comprising:
a centralized data storage module for receiving, storing and providing access to data relating to litigation cases;
a computer processor for executing program instructions, the computer processor coupled to the centralized data storage module;
program memory, coupled to the computer processor, for storing program instruction steps for execution by the computer processor;
an input device, coupled to the computer processor, for inputting at least some of the data relating to the litigation cases; and
a display device, coupled to the computer processor, for displaying data retrieved from the centralized data storage module and related to the litigation cases;
wherein:
the program instruction steps control the processor such that access to the retrieved data is limited to authorized individuals and/or authorized subject areas; and
the data displayed by the display device relates to at least one of:
(a) amounts recovered by the insurance company in subrogation actions;
(b) amounts recovered by the insurance company in connection with frivolous claims defended by the insurance company; and
(c) costs incurred by the insurance company in bringing an interpleader action.

2. The computer system of claim 1, wherein the display device displays data retrieved from the centralized data storage module and related to a respective litigation at a plurality of points in time from (i) intake of the respective litigation case into the computer system to (ii) disposition of the litigation case.

3. The computer system of claim 1, further comprising:
a communication device coupled to the computer processor;
and wherein the computer processor is programmed to control the communication device to output data related to the litigation cases to at least one other computer system.

4. The computer system of claim 3, wherein the at least one other computer system includes an outside counsel engagement system.

5. The computer system of claim 3, wherein the at least one other computer system includes an operational risk analysis system.

6. The computer system of claim 1, wherein the costs incurred by the insurance company related to the interpleader action include attorneys' fees and court costs incurred in filing the interpleader action.

7. The computer system of claim 1, wherein the program instruction steps control the computer processor to automatically estimate a monetary amount to be recovered by the insurance company in a subrogation action related to a respective one of the litigation cases.

8. A computer-implemented method for tracking litigation cases at an insurance company, the method comprising:
receiving litigation case data in a centralized data storage module;
storing the litigation case data in the centralized data storage module;
permitting access to the stored litigation case data, such that access to the stored data is limited to authorized individuals and/or authorized subject areas; and
displaying the data to which access is permitted, the displayed data relating to at least one of:
(a) amounts recovered by the insurance company in subrogation actions;
(b) amounts recovered by the insurance company in connection with frivolous claims defended by the insurance company; and
(c) costs incurred by the insurance company in bringing an interpleader action.

9. The method of claim 8, wherein the displayed data is related to a respective litigation at a plurality of points in time from (i) intake of the respective litigation case into the centralized data storage module to (ii) disposition of the litigation case.

10. The method of claim 8, further comprising:
outputting data related to the litigation cases to at least one other computer system that is separate from the centralized data storage module.

11. The method of claim 10, wherein the at least one other computer system includes an outside counsel engagement system.

12. The method of claim 10, wherein the at least one other computer system includes an operational risk analysis system.

13. The method of claim 8, wherein the costs incurred by the insurance company related to the interpleader action include attorneys' fees and court costs incurred in filing the interpleader action.

14. The method of claim 8, further comprising:
automatically estimating a monetary amount to be recovered by the insurance company in a subrogation action related to a respective one of the litigation cases.

15. A computer system for tracking litigation cases at an insurance company, the computer system comprising:
a centralized data storage module for receiving, storing and providing access to data relating to litigation cases;
a computer processor for executing program instructions, the computer processor coupled to the centralized data storage module;
program memory, coupled to the computer processor, for storing program instruction steps for execution by the computer processor;
an input device, coupled to the computer processor, for inputting at least some of the data relating to the litigation cases; and
a display device, coupled to the computer processor, for displaying:
(a) data retrieved from the centralized data storage module and related to the litigation cases; and
(b) data entry forms for entering data related to:
(i) intake of a litigation case into the computer system;
(ii) selection of counsel to represent a party to a litigation case;
(iii) calendaring events scheduled to occur in a litigation case;
(iv) a name of a judge, mediator or arbitrator assigned to a litigation case;
(v) dollar amounts recovered by the insurance company with respect to a litigation case;
(vi) an interpleader action instituted by the insurance company in connection with a litigation case; and
(vii) disposition of a litigation case.

16. The computer system of claim 15, wherein:
the program memory stores a plurality of program modules for selectively being executed by the computer processor, each of the program modules configured for use by a respective department of the insurance company.

17. The computer system of claim 16, wherein:
the plurality of program modules includes a first program module for use by a first department of the insurance company and a second program module for use by a second department of the insurance company;
the first program module, when executed by the computer processor, causes the display device to display a first set of intake data entry forms for entering case intake information for the first department of the insurance company; and
the second program module, when executed by the computer processor, causes the display device to display a second set of intake data entry forms, the second set of intake data entry forms different from the first set of intake data entry forms, the second set of intake data entry forms for entering case intake information for the second department of the insurance company.

18. The computer system of claim 17, wherein:
the first program module, when executed by the computer processor, causes the display device to display a first event calendaring data entry form for use by the first department of the insurance company; and
the second program module, when executed by the computer processor, causes the display device to display a second event calendaring data entry form for use by the second department of the insurance company, the second event calendaring data entry form different from the first event calendaring data entry form.

19. The computer system of claim 15, wherein the program memory stores program instructions for controlling the computer processor to generate reports from the data relating to litigation cases stored in the centralized data storage module.

20. The computer system of claim 19, wherein the reports generated by the computer processor include (a) case status reports; (b) periodic scorecard reports; (c) reinsurance reports; and (d) custom reports.

21. The computer system of claim 15, wherein a data entry form displayed by the display device for entry of data related to dollar amounts recovered by the insurance company includes at least one data field for entry of data related to one or more of: (a) recovery via a subrogation claim asserted by the insurance company; (b) recovery from a reinsurer; and (c) recovery of attorneys' fees expended by the insurance company with respect to (i) an interpleader action; or (ii) a litigation case ruled to have been frivolously asserted.

22. The computer system of claim 15, wherein the program memory stores program instructions for controlling the computer processor to cause the display device to display a dashboard screen that indicates respective case loads for litigation management employees of the insurance company.

23. The computer system of claim 15, wherein the program memory stores program instructions for controlling the computer processor to initiate a process to engage litigation counsel to defend a respective one of the litigation cases.

24. The computer system of claim 15, wherein the program memory stores program instructions for controlling the computer processor to transfer data from the computer system to a subrogation case management system operated by the insurance company.
